(19) United States
(12) Patent Application Publication
(10) Pub. No.: US 2026/0202934 A1
(43) Pub. Date: Jul. 16, 2026

(54) ELECTRONIC DEVICE

(71) Applicant: Samsung Display Co., LTD., Yongin-si (KR)

(72) Inventors: SOOWON KIM, Yongin-si (KR); HYUN JAE LEE, Yongin-si (KR); CHOONHYOP LEE, Yongin-si (KR); JIN-TAEK HONG, Yongin-si (KR)

(21) Appl. No.: 19/389,353

(22) Filed: Nov. 14, 2025

(30) Foreign Application Priority Data
Jan. 10, 2025 (KR) 10-2025-0004247

(51) Int. Cl. G06F 3/041; G06F 3/044; G09G 3/32; G09G 3/3291

(52) U.S. Cl. CPC G06F 3/04182; G06F 3/0443; G06F 3/0446; G09G 3/32; G09G 3/3291; G09G 2310/0275; G09G 2330/021

(57) ABSTRACT

An electronic device includes a display panel including a display layer, and a sensor layer, a display driving circuit, which receives information about a display image and outputs a data voltage to the display layer, and a touch driving circuit, which outputs a transmission signal to the sensor layer. The display driving circuit includes a conversion unit, which divides the information about the display image into a plurality of blocks and generates representative value data of each of the plurality of blocks. The touch driving circuit includes a determination unit, which determines a noise level of the representative value data, a storage unit in which a touch driving condition corresponding to the noise level is stored, and an adjustment unit, which adjusts the transmission signal based on the touch driving condition.

This application claims priority to Korean Patent Application No. 10-2025-0004247, filed on January 10, 2025, and all the benefits accruing therefrom under 35 U.S.C. §119, the content of which in its entirety is herein incorporated by reference.

### BACKGROUND

The present disclosure herein relates to an electronic device, and more particularly, to an electronic device with reduced power consumption and improved touch sensitivity.

Multimedia electronic devices, such as a television, a mobile phone, a tablet computer, a navigation system, and a game console, are provided with a display device for displaying an image. A display device includes a display panel and a driving unit. The driving unit includes a scan driving circuit that provides scan signals to a plurality of scan lines, a display driving circuit that provides data voltages to data lines, and a touch driving circuit that outputs a transmission signal to a sensor layer and receives a reception signal from the sensor layer.

### SUMMARY

The present disclosure provides an electronic device with reduced power consumption and improved touch sensitivity.

An embodiment of the invention provides an electronic device including a display panel including a display layer, which displays an image, and a sensor layer, which detects an external input, a display driving circuit, which receives information about a display image from an outside and outputs a data voltage to the display layer, and a touch driving circuit, which outputs a transmission signal to the sensor layer. The display driving circuit includes a conversion unit, which divides the information about the display image into a plurality of blocks and generates representative value data of each of the plurality of blocks. The touch driving circuit includes a determination unit, which determines a noise level of the representative value data received from the display driving circuit, a storage unit in which a touch driving condition corresponding to the noise level is stored, and an adjustment unit, which adjusts the transmission signal based on the touch driving condition.

In an embodiment, the information about the display image may be updated on a frame-by-frame basis, and the touch driving circuit may adjust the transmission signal on the frame-by-frame basis.

In an embodiment, the sensor layer may include a plurality of first sensing electrodes and a plurality of second sensing electrodes intersecting the plurality of first sensing electrodes, the transmission signal may be output to each of the plurality of first sensing electrodes, and the adjustment unit may adjust the transmission signal based on the touch driving condition corresponding to each of the plurality of first sensing electrodes.

In an embodiment, the sensor layer may include a plurality of first sensing electrodes and a plurality of second sensing electrodes intersecting the plurality of first sensing electrodes, the touch driving circuit may receive a reception signal from the plurality of second sensing electrodes, and the touch driving circuit may further include a setting unit, which sets the touch driving condition based on the reception signal.

In an embodiment, the setting unit may include a measurement unit, which receives the reception signal from the sensor layer which receives a first transmission signal having a first touch driving condition and measures noise information, and a judgment unit, which judges whether the first touch driving condition satisfies a reference value based on the noise information, and when the first touch driving condition satisfies the reference value, the storage unit may be configured to store the first touch driving condition.

In an embodiment, the setting unit may further include a changing unit, which generates a second transmission signal, having a second touch driving condition different from the first touch driving condition, when the first touch driving condition does not satisfy the reference value.

In an embodiment, the display layer may include a plurality of pixels, and the number of the plurality of blocks is less than the number of the plurality of the pixels.

In an embodiment, the sensor layer may include a plurality of first sensing electrodes and a plurality of second sensing electrodes intersecting the plurality of first sensing electrodes, the sensor layer may have a plurality of sensing units defined therein, each of the plurality of sensing units may include a region in which one first sensing electrode among the plurality of first sensing electrodes intersects one second sensing electrode among the plurality of second sensing electrodes, and the plurality of blocks may correspond one-to-one with the plurality of sensing units.

In an embodiment, the display layer may include a plurality of pixels, and the representative value data may include luminance information about some pixels, among the plurality of pixels, which overlap one block among the plurality of blocks.

In an embodiment, the representative value data may be average value data of the luminance information about the some pixels.

In an embodiment, the representative value data may be maximum value data of the luminance information about the some pixels.

In an embodiment, the touch driving condition may include voltage data of the transmission signal.

In an embodiment, the display driving circuit may further include a compression unit, which compresses the representative value data, and the touch driving circuit may further include a restoring unit, which restores the compressed representative value data and transfers the representative value data, which is restored from the compression, to the determination unit.

In an embodiment of the invention, an electronic device includes a display panel including a display layer, which displays an image and a sensor layer, which detects an external input, a display driving circuit, which receives information about a display image from an outside, and outputs a data voltage to the display layer, and a touch driving circuit, which outputs a transmission signal to the sensor layer. The display driving circuit may include a conversion unit, which divides the information about the display image into a plurality of blocks and generates representative value data of each of the plurality of blocks, and a compression unit, which compresses the representative value data and transfers the compressed representative value data to the touch driving circuit. The touch driving circuit includes a restoring unit, which receives and restores the compressed representative value data, a determination unit, which determines a noise level of the representative value data, which is restored, a storage unit in which a touch driving condition corresponding to the noise level is stored, and an adjustment unit, which adjusts the transmission signal based on the touch driving condition.

In an embodiment, the information about the display image may be updated on a frame-by-frame basis, and the touch driving circuit may adjust the transmission signal on the frame-by-frame basis.

In an embodiment, the sensor layer may include a plurality of first sensing electrodes and a plurality of second sensing electrodes intersecting the plurality of first sensing electrodes, the transmission signal may be output to each of the plurality of first sensing electrodes, and the adjustment unit may adjust the transmission signal based on the touch driving condition corresponding to each of the plurality of first sensing electrodes.

In an embodiment, the sensor layer may include a plurality of first sensing electrodes and a plurality of second sensing electrodes intersecting the plurality of first sensing electrodes, the touch driving circuit may receive a reception signal from the plurality of second sensing electrodes, and the touch driving circuit may further include a setting unit, which sets the touch driving condition based on the reception signal.

In an embodiment, the setting unit may include a measurement unit, which receives the reception signal from the sensor layer which receives a first transmission signal having a first touch driving condition and measures noise information, a judgment unit, which judges whether the first touch driving condition satisfies a reference value based on the noise information, and a changing unit, which generates a second transmission signal having a second touch driving condition different from the first touch driving condition when the first touch driving condition does not satisfy the reference value, and the storage unit may be configured to store the first touch driving condition when the first touch driving condition satisfies the reference value.

In an embodiment, the display layer may include a plurality of pixels, the sensor layer may include a plurality of first sensing electrodes and a plurality of second sensing electrodes intersecting the plurality of first sensing electrodes, the sensor layer may have a plurality of sensing units defined therein, the plurality of sensing units each including a region in which one first sensing electrode among the plurality of first sensing electrodes intersects one second sensing electrode among the plurality of second sensing electrodes, the number of the plurality of blocks may be less than the number of the plurality of pixels, and the plurality of blocks may correspond one-to-one with the plurality of sensing units.

In an embodiment, the display layer may include a plurality of pixels, the representative value data includes luminance information about some pixels, among the plurality of pixels, which overlap one block among the plurality of blocks, and the touch driving condition may include voltage data of the transmission signal.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1 is a block diagram of an electronic device according to an embodiment of the invention;

FIG. 2 illustrates schematic views of electronic devices according to various embodiments of the invention;

FIG. 3 is a diagram for explaining an operation of an electronic device according to an embodiment of the invention;

FIG. 4A is a cross-sectional view of a display panel according to an embodiment of the invention;

FIG. 4B is a cross-sectional view of a display panel according to an embodiment of the invention;

FIG. 5 is a cross-sectional view of a display panel according to an embodiment of the invention;

FIG. 6 is a block diagram of a display layer and a display driving unit according to an embodiment of the invention;

FIG. 7 is a block diagram of a sensor layer and a touch driving circuit according to an embodiment of the invention;

FIG. 8 is a diagram for explaining a driving principle of a display driving circuit and a touch driving circuit according to an embodiment of the invention;

FIG. 9A is a diagram for explaining an operational principle of a conversion unit according to an embodiment of the invention;

FIG. 9B is a diagram for explaining an operational principle of a conversion unit according to an embodiment of the invention;

FIG. 10 is a diagram for explaining a transmission signal according to an embodiment of the invention;

FIG. 11A is a diagram illustrating a first transmission signal shown in FIG. 10, according to an embodiment of the invention;

FIG. 11B is a diagram illustrating a second transmission signal shown in FIG. 10, according to an embodiment of the invention;

FIG. 12 is a diagram illustrating a first transmission signal shown in FIG. 10, according to an embodiment of the invention;

FIG. 13A is a diagram illustrating a second transmission signal shown in FIG. 10, according to an embodiment of the invention;

FIG. 13B is a diagram illustrating a second transmission signal shown in FIG. 10, according to an embodiment of the invention;

FIG. 13C is a diagram illustrating a second transmission signal shown in FIG. 10, according to an embodiment of the invention;

FIG. 14 is a diagram for explaining a driving principle of a touch driving circuit according to an embodiment of the invention;

FIG. 15 is a diagram for explaining a driving principle of a touch driving circuit according to an embodiment of the invention;

FIG. 16 is a diagram for explaining an operational principle of a setting unit according to an embodiment of the invention; and

FIG. 17 is a diagram for explaining a driving principle of a touch driving circuit according to an embodiment of the invention.

### DETAILED DESCRIPTION

In this specification, it will be understood that when an element (or a region, a layer, a portion, or the like) is referred to as being "on", "connected to" or "coupled to" another element, it may be directly disposed on, connected to, or coupled to the other element, or other elements may be disposed therebetween.

Like reference numerals or symbols refer to like elements throughout. In the drawings, the thickness, ratio, and size of the elements are exaggerated for effectively describing the technical contents. As used herein, the term "and/or" includes any and all combinations of one or more of the associated listed elements.

It will be understood that, although the terms “first”, “second”, etc. may be used herein to describe various elements, the elements are not to be limited by these terms. These terms are only used to distinguish one element, component, region, layer or section from another element, component, region, layer or section. For instance, a first element, component, region, layer or section discussed below could be termed a second element, component, region, layer or section without departing from the scope of the invention. Similarly, a second element, component, region, layer or section could be termed a first element, component, region, layer or section. In this specification, the singular expressions "a", "an" and "the" are intended to include the plural forms as well, unless the context clearly indicates otherwise.

In addition, the terms "below", “under”, "on the lower side", "above", “over”, "on the upper side", or the like may be used to describe the relationships between the elements illustrated in the drawings. These terms are relative concepts and are described based on the directions indicated in the drawings.

It will be further understood that the terms "comprises, includes, has" and/or "comprising, including, having", when used in this specification, specify the presence of stated features, numbers, steps, operations, elements, components or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the invention are described with reference to the accompanying drawings.

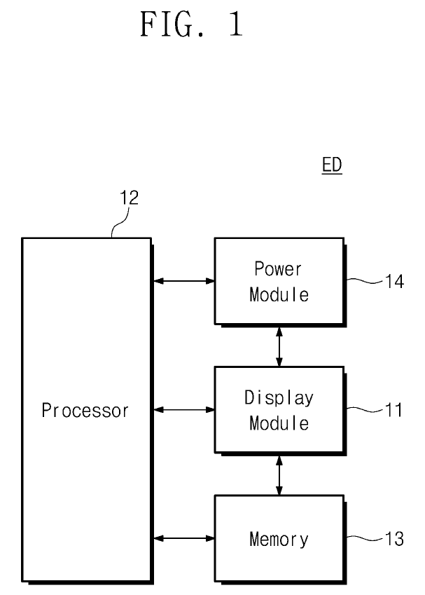

FIG. 1 is a block diagram of an electronic device ED according to an embodiment of the invention.

Referring to FIG. 1, the electronic device ED according to an embodiment may include a display module 11, a processor 12, a memory 13, and a power module 14.

The display module 11 may display an image. The image may include a still image as well as a moving image. The processor 12 may include at least one among a central processing unit (CPU), an application processor (AP), a graphic processing unit (GPU), a communication processor (CP), an image signal processor (ISP), and a controller. The processor 12 may be configured to control an operation of the display module 11.

In the memory 13, data information for an operation of the processor 12 or the display module 11 may be stored. When the processor 12 executes an application stored in the memory 13, an image data signal and/or an input control signal are transferred to the display module 11, and the display module 11 may output image information through a display screen by processing the received signal.

The power module 14 may include a power supply module such as a power adaptor or a battery device, and may include a power conversion module that generates a power for an operation of the electronic device ED by converting a power supplied by the power supply module.

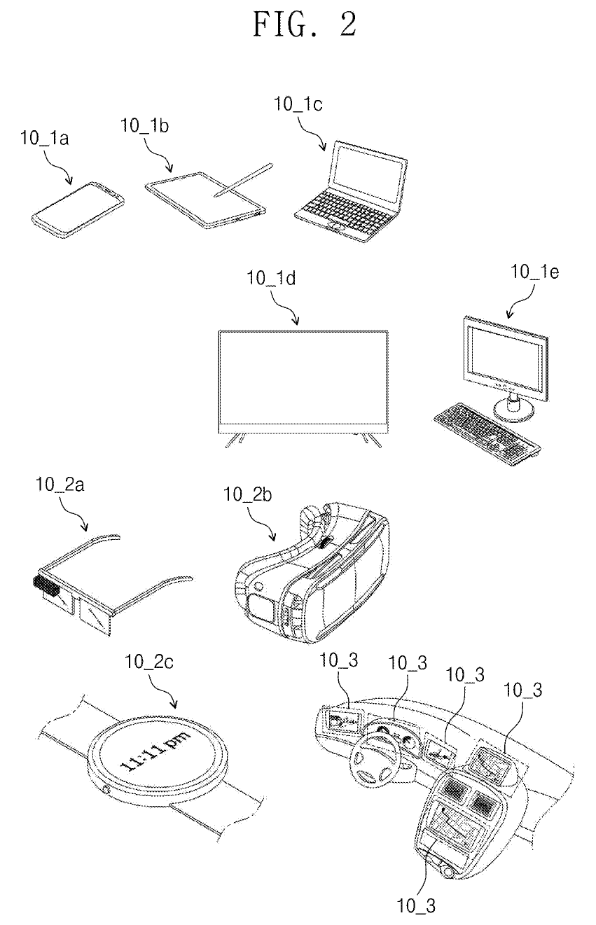

FIG. 2 illustrates schematic views of electronic devices according to various embodiments of the invention.

Referring to FIG. 2, various electronic devices, to which a display device is applied, according to embodiments may include an image displaying electronic device, such as a smart phone 10_1a, a tablet PC 10_1b, a laptop 10_1c, a TV 10_1d, or a desk monitor 10_1e, and also include a wearable electronic device including a display module, such as smart glasses 10_2a, a head mount display 10_2b, or a smart watch 10_2c, and a vehicular electronic device 10_3 including a display module, such as a car dashboard, a center fascia, a center information display (CID) disposed in a dashboard, or a room mirror display.

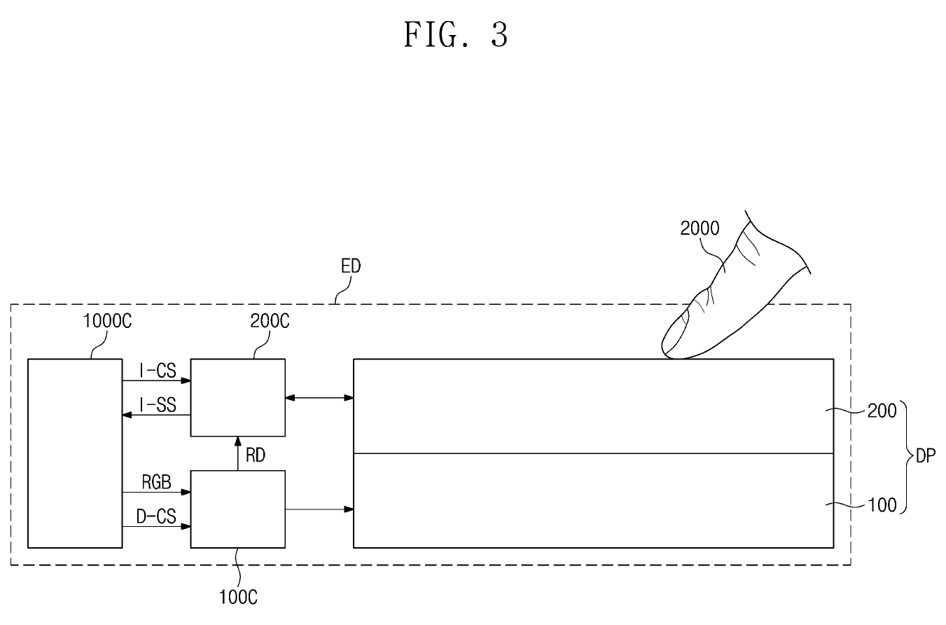

FIG. 3 is a diagram for explaining an operation of an electronic device ED according to an embodiment of the invention.

Referring to FIG. 3, the electronic device ED may include a display panel DP, a display driving unit 100C, a sensor driving unit 200C, and a main driving unit 1000C. The display panel DP may include a display layer 100 and a sensor layer 200.

The display layer 100 may be a component that displays substantially an image. The display layer 100 may be a light-emitting-type display layer, and for example, the display layer 100 may be an organic light-emitting display layer, an inorganic light-emitting display layer, an organic-inorganic light-emitting display layer, a quantum-dot display layer, a micro-LED display layer, or a nano-LED display layer.

The sensor layer 200 may be disposed on the display layer 100. The sensor layer 200 may detect an external input applied from the outside. The external input may include all input means capable of providing a change in capacitance. For example, the sensor layer 200 may detect both an active input from an input device and a passive input from a touch 2000. The input device may be an active-type input means for providing a driving signal, and may be, for example, an active pen. The touch 2000 may include all input means capable of providing a change in capacitance, such as a body of a user, and a passive pen.

The main driving unit 1000C may control overall operations of the electronic device ED. For example, the main driving unit 1000C may control an operation of the display driving unit 100C and the sensor driving unit 200C. The main driving unit 1000C may include at least one micro-processor, and may be referred to as a “host”. The main driving unit 1000C may further include a graphic controller.

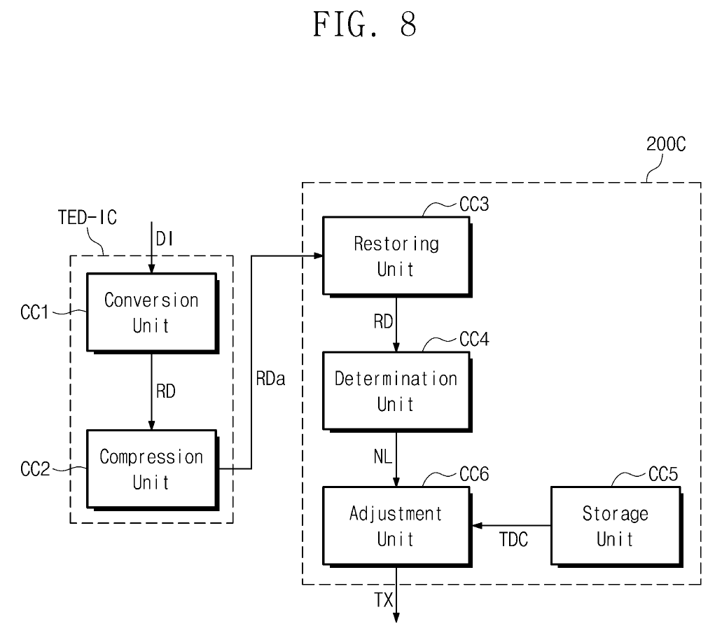

The display driving unit 100C may drive the display layer 100. The display driving unit 100C may receive image data RGB and a control signal D-CS from the main driving unit 1000C. The control signal D-CS may include various signals. The image data RGB may include information DI about a display image (see FIG. 8) displayed on each of a plurality of frames. For example, the information DI about the display image (see FIG. 8) may include luminance information about pixels. The control signal D-CS may include an input vertical synchronization signal, an input horizontal synchronization signal, a main clock, a data enable signal, and the like. The display driving unit 100C may generate, based on the control signal D-CS, a vertical synchronization signal and a horizontal synchronization signal for controlling a timing at which a signal is provided to the display layer 100.

The sensor driving unit 200C may drive the sensor layer 200. The sensor driving unit 200C may receive a control signal I-CS from the main driving unit 1000C. The control signal I-CS may include a mode determination signal or a clock signal that determines a driving mode of the sensor driving unit 200C.

The sensor driving unit 200C may calculate coordinate information about an input based on a signal received from the sensor layer 200, and may provide, to the main driving unit 1000C, a coordinate signal I-SS having the coordinate information. The main driving unit 1000C may execute an operation corresponding to an input of a user based on the coordinate information I-SS. For example, the main driving unit 1000C may operate the display driving unit 100C such that a new application image is displayed on the display layer 100 based on the coordinate information I-SS. Alternatively, the main driving unit 1000C may operate the display driving unit 100C such that a trajectory image corresponding to the coordinate signal I-SS is displayed.

In an embodiment of the invention, the display driving unit 100C may output, to the sensor driving unit 200C, conversion data RD obtained by converting the information DI about the display image (see FIG. 8). The sensor driving unit 200C may drive the sensor layer 200 by referring to the received conversion data RD. Hereinafter, the sensor driving unit 200C may be referred to as a “touch driving circuit 200C”.

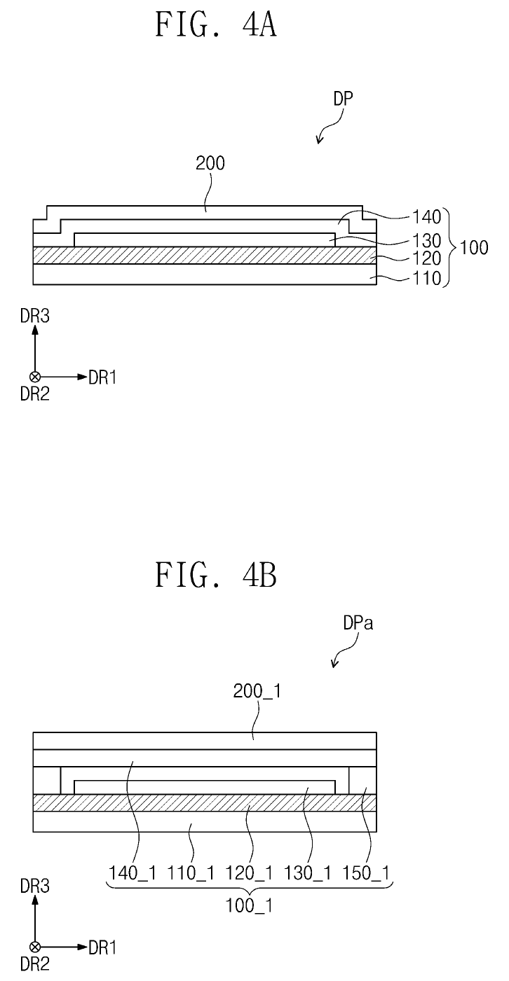

FIG. 4A is a cross-sectional view of a display panel DP according to an embodiment of the invention.

Referring to FIG. 4A, the display panel DP may include a display layer 100 and a sensor layer 200.

The display layer 100 may include a base layer 110, a circuit layer 120, a light-emitting element layer 130, and an encapsulation layer 140.

The base layer 110 may be a member that provides a base surface on which the circuit layer 120 is disposed. The base layer 110 may be a glass substrate, a metal substrate, a polymer substrate, or the like. However, an embodiment of the invention is not limited thereto, and the base layer 110 may be an inorganic layer, an organic layer, or a composite material layer.

The circuit layer 120 may be disposed on the base layer 110. The circuit layer 120 may include an insulating layer, a semiconductor pattern, a conductor pattern, signal lines, and the like. The insulating layer, a semiconductor layer, and a conductor layer are formed on the base layer 110 through coating, deposition, or the like, and then, the insulating layer, the semiconductor layer, and the conductor layer may be selectively patterned by performing a photolithographic process multiple times. Thereafter, the semiconductor pattern, the conductor pattern, and the signal lines included in the circuit layer 120 may be formed.

The light-emitting element layer 130 may be disposed on the circuit layer 120. The light-emitting element layer 130 may include a light-emitting element. For example, the light-emitting element layer 130 may include an organic light-emitting material, an inorganic light-emitting material, an organic-inorganic light-emitting material, quantum dots, quantum rods, a micro-LED, or a nano-LED.

The encapsulation layer 140 may be disposed on the light-emitting element layer 130. The encapsulation layer 140 may protect the light-emitting element layer 130 from moisture, oxygen, and dust particles.

The sensor layer 200 may be disposed on the display layer 100. The sensor layer 200 may detect an external input applied from the outside. The external input may be an input of a user. The input of the user may include various types of external inputs such as a portion of a body of the user, light, heat, a pen, and pressure.

The sensor layer 200 may be formed on the display layer 100 through continuous processes. In this case, it may be said that the sensor layer 200 is directly disposed on the display layer 100. The wording, “directly disposed on”, may mean that a third component is not disposed between the sensor layer 200 and the display layer 100. That is, an additional adhesive member may not be disposed between the sensor layer 200 and the display layer 100. Alternatively, the sensor layer 200 and the display layer 100 may be bonded to each other through an adhesive member. The adhesive member may include a typical adhesive or a bonding agent.

Although not illustrated, the electronic device ED (see FIG. 3) may further include an anti-reflection layer and an optical layer, which are disposed on the sensor layer 200. The anti-reflection layer may reduce a reflectance for external light incident from the outside of the electronic device ED (see FIG. 3). The optical layer may improve a frontal luminance of the electronic device ED (see FIG. 3) by controlling a direction of the light incident from the display layer 100.

FIG. 4B is a cross-sectional view of a display panel DPa according to an embodiment of the invention.

Referring to FIG. 4B, the display panel DPa may include a display layer 100_1 and a sensor layer 200_1.

The display layer 100_1 may include a base substrate 110_1, a circuit layer 120_1, a light-emitting element layer 130_1, an encapsulation substrate 140_1, and a bonding member 150_1.

The base substrate 110_1 and the encapsulation substrate 140_1 may each be a glass substrate, a metal substrate, or a polymer substrate, but are not particularly limited thereto.

The bonding member 150_1 may be disposed between the base substrate 110_1 and the encapsulation substrate 140_1. The bonding member 150_1 may bond the encapsulation substrate 140_1 to the base substrate 110_1 or the circuit layer 120_1. The bonding member 150_1 may include an inorganic material or an organic material. For example, the inorganic material may include a frit seal, and the organic material may include a photocurable resin or a photo-plastic resin. However, the material constituting the bonding member 150_1 is not limited to the example as above.

The sensor layer 200_1 may be directly disposed on the encapsulation substrate 140_1. The wording, “directly disposed on”, may mean that a third component is not disposed between the sensor layer 200_1 and the encapsulation substrate 140_1. That is, an additional adhesive member may not be disposed between the sensor layer 200_1 and the display layer 100_1. However, an embodiment of the invention is not limited thereto, and an adhesive layer may be additionally disposed between the sensor layer 200_1 and the encapsulation substrate 140_1.

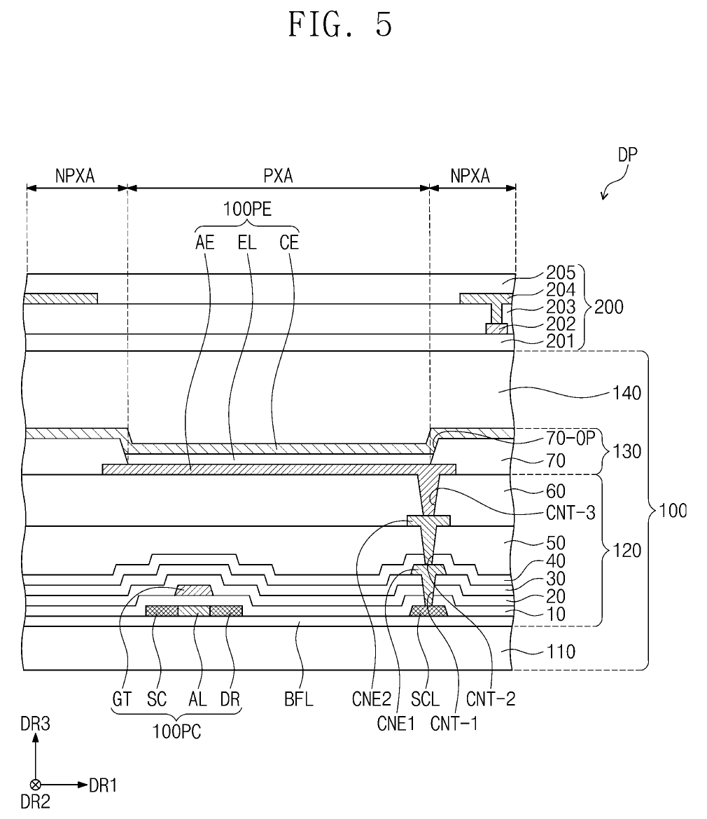

FIG. 5 is a cross-sectional view of the display panel DP according to an embodiment of the invention.

Referring to FIG. 5, at least one inorganic layer is formed on an upper surface of the base layer 110. The inorganic layer may include at least one among aluminum oxide, titanium oxide, silicon oxide, silicon nitride, silicon oxynitride, zirconium oxide, and hafnium oxide. The inorganic layer may be formed as a plurality of layers. The plurality of inorganic layers may constitute a barrier layer and/or a buffer layer. In this embodiment, it is illustrated that the display layer 100 includes a buffer layer BFL.

The buffer layer BFL may improve a bonding strength between the base layer 110 and semiconductor patterns SC, AL, and DR. The buffer layer BFL may include at least one among silicon oxide, silicon nitride, and silicon oxynitride. For example, the buffer layer BFL may include a structure in which silicon oxide layers and silicon nitride layers are alternately stacked.

The semiconductor patterns may be disposed on the buffer layer BFL. The semiconductor patterns SC, AL, and DR may include polysilicon. However, the semiconductor patterns SC, AL, and DR are not limited thereto, and may include amorphous silicon, low-temperature crystalline silicon, or oxide semiconductors.

FIG. 5 only illustrates a portion of the semiconductor patterns SC, AL, and DR, and the semiconductor patterns SC, AL, and DR may further be disposed in other regions. The semiconductor patterns SC, AL, and DR may be arranged in accordance with a specific rule throughout pixels. The semiconductor patterns SC, AL, and DR may have different electrical properties according to whether to be doped or not. The semiconductor patterns SC, AL, and DR may include first regions SC and DR having high conductivity and a second region AL having low conductivity. The first regions SC and DR may be doped with an N-type dopant or a P-type dopant. A P-type transistor may include a region doped with the P-type dopant, and an N-type transistor may include a region doped with the N-type dopant. The second region AL may be an undoped region, or a region doped at a lower concentration than the first regions SC and DR.

The first regions SC and DR may have a higher conductivity than the second region AL, and substantially serve as electrodes or signal lines. The second region AL may substantially correspond to an active (or channel) portion of the transistor. In other words, one portion of the semiconductor patterns SC, AL, and DR may be the active portion of the transistor, another portion of the semiconductor patterns SC, AL, and DR may be a source or drain of the transistor, and still another portion of the semiconductor patterns SC, AL, and DR may be a connection electrode or connection signal line.

Each of the pixels may have an equivalent circuit including at least one transistor, at least one capacitor, and a light-emitting element, and an equivalent circuit diagram of the pixel may be transformed into various forms. In FIG. 5, one transistor 100PC and one light-emitting element 100PE included in the pixel are illustrated as an example.

A source region SC, an active region AL, and a drain region DR of the transistor 100PC may be formed from the semiconductor patterns SC, AL, and DR. In a cross-sectional view, the source region SC and the drain region DR may extend in opposite directions from the active region AL. FIG. 5 illustrates a portion of connection signal line SCL formed from the semiconductor patterns SC, AL, and DR. Although not shown separately, the connection signal line SCL may be connected to the drain region DR of the transistor 100PC on the plane.

A first insulating layer 10 may be disposed on the buffer layer BFL. The first insulating layer 10 may overlap a plurality of pixels in common and may cover the semiconductor patterns. The first insulating layer 10 may be an inorganic layer and/or an organic layer, and may have a single-layer or multi-layer structure. The first insulating layer 10 may include at least one among aluminum oxide, titanium oxide, silicon oxide, silicon nitride, silicon oxynitride, zirconium oxide, and hafnium oxide. In this embodiment, the first insulating layer 10 may be a single-layered silicon oxide layer. Not only the first insulating layer 10 but also an insulating layer of the circuit layer 120 to be described later may be an inorganic layer and/or an organic layer, and may have a single-layer or multi-layer structure. The inorganic layer may include at least one among the materials described above, but is not limited thereto.

A gate GT of the transistor 100PC may be disposed on the first insulating layer 10. The gate GT may be a portion of a metal pattern. The gate GT overlaps the active region AL. In a process of doping the semiconductor patterns SC, AL, and DR, the gate GT may function as a mask.

A second insulating layer 20 may be disposed on the first insulating layer 10 and may cover the gate GT. The second insulating layer 20 may overlap the pixels in common. The second insulating layer 20 may be an inorganic layer and/or an organic layer, and may have a single-layer or multi-layer structure. The second insulating layer 20 may include at least one among silicon oxide, silicon nitride, and silicon oxynitride. In this embodiment, the second insulating layer 20 may have a multi-layer structure including a silicon oxide layer and a silicon nitride layer.

A third insulating layer 30 may be disposed on the second insulating layer 20. The third insulating layer 30 may have a single-layer or multi-layer structure. For example, the third insulating layer 30 may have a multi-layer structure including a silicon oxide layer and a silicon nitride layer.

A first connection electrode CNE1 may be disposed on the third insulating layer 30. The first connection electrode CNE1 may be connected to the connection signal line SCL through a contact hole CNT-1 that penetrates the first, second, and third insulating layers 10, 20, and 30.

A fourth insulating layer 40 may be disposed on the third insulating layer 30. The fourth insulating layer may be a single-layered silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 that penetrates the fourth insulating layer 40 and the fifth insulating layer 50.

A sixth insulating layer 60 may be disposed on the fifth insulating layer 50 and may cover the second connection electrode CNE2. The sixth insulating layer 60 may be an organic layer.

The light-emitting element layer 130 may be disposed on the circuit layer 120. The light-emitting element layer 130 may include the light-emitting element 100PE. For example, the light-emitting element layer 130 may include an organic light-emitting material, an inorganic light-emitting material, an organic-inorganic light-emitting material, quantum dots, quantum rods, a micro-LED, or a nano-LED. Hereinafter, it is described as an example that the light-emitting element 100PE is an organic light-emitting element, but an embodiment of the invention is not particularly limited thereto.

The light-emitting element 100PE may include a first electrode AE, a light-emitting layer EL, and a second electrode CE.

The first electrode AE may be disposed on the sixth insulating layer 60. The first electrode AE may be connected to the second connection electrode CNE2 through a contact hole CNT-3 that penetrates the sixth insulating layer 60.

A pixel definition film 70 may be disposed on the sixth insulating layer 60 and may cover a portion of the first electrode AE. In the pixel definition film 70, an opening 70-OP may be defined. The opening 70-OP of the pixel definition film 70 may expose at least one portion of the first electrode AE.

The display panel DP may include a light-emitting region PXA and a non-light-emitting region NPXA adjacent to the light-emitting region PXA. The non-light-emitting region NPXA may surround the light-emitting region PXA. In this embodiment, the light-emitting region PXA is defined to correspond a portion of the first electrode AE exposed by the opening 70-OP.

The light-emitting layer EL may be disposed on the first electrode AE. The light-emitting layer EL may be disposed in a region corresponding to the opening 70-OP. That is, the light-emitting layer EL may be formed separately for each pixel. When the light-emitting layer EL is formed separately for each pixel, each of the light-emitting layers EL may emit light of at least one color among blue, red, and green colors. However, an embodiment of the invention is not limited thereto, and the light-emitting layer EL may be connected to the pixels and provided in common. In this case, the light-emitting layer EL may provide blue color light or may provide white color light.

The second electrode CE may be disposed on the light-emitting layer EL. The second electrode CE may be an integral shape and may be commonly disposed in a plurality of the pixels.

Although not illustrated, a hole control layer may be disposed between the first electrode AE and the light-emitting layer EL. The hole control layer may be disposed in common in the light-emitting region PXA and the non-light-emitting region NPXA. The hole control layer may include a hole transport layer and may further include a hole injection layer. An electron control layer may be disposed between the light-emitting layer EL and the second electrode CE. The electron control layer may include an electron transport layer and may further include an electron injection layer. The hole control layer and the electron control layer may be formed in common in a plurality of pixels using an open mask.

The encapsulation layer 140 may be disposed on the light-emitting element layer 130. Although the encapsulation layer 140 may include an inorganic layer, an organic layer, and an inorganic layer, which are sequentially stacked, the layers constituting the encapsulation layer 140 are not limited thereto. The inorganic layers may protect the light-emitting element layer 130 from moisture and oxygen, and the organic layer may protect the light-emitting element layer 130 from foreign substances such as dust particles. The inorganic layers may include a silicon nitride layer, a silicon oxynitride layer, a silicon oxide layer, a titanium oxide layer, an aluminum oxide layer, or the like. The organic layer may include an acrylic organic layer but is not limited thereto.

The sensor layer 200 may include a base layer 201, a first conductive layer 202, an intermediate insulating layer 203, a second conductive layer 204, and a cover layer 205.

The base layer 201 may be an inorganic layer that includes at least one among silicon nitride, silicon oxynitride, and silicon oxide. Alternatively, the base layer 201 may be an organic layer that includes an epoxy resin, an acrylate-based resin, or an imide-based resin. The base layer 201 may have a single-layer structure or may have a multi-layer structure in which layers are stacked along the third direction DR3.

The first conductive layer 202 and the second conductive layer 204 may each have a single-layer structure or a multi-layer structure in which layers are stacked along the third direction DR3.

The conductive layer having the single-layer structure may include a metal layer or a transparent conductive layer. The metal layer may include molybdenum, silver, titanium, copper, aluminum, or alloy thereof. The transparent conductive layer may include a transparent conductive oxide, such as indium tin oxide (ITO), indium zinc oxide (IZO), zinc oxide (ZnO), or indium zinc tin oxide (IZTO). In addition, the transparent conductive layer may include a conductive polymer such as PEDOT, a metal nanowire, graphene, and the like.

The conductive layer having the multi-layer structure may include metal layers. The metal layers may have, for example, a three-layer structure of titanium/aluminum/titanium. The conductive layer having the multi-layer structure may include at least one metal layer and at least one transparent conductive layer.

At least one of the intermediate insulating layer 203 or the cover layer 205 may include an inorganic film. The inorganic film may include at least one among aluminum oxide, titanium oxide, silicon oxide, silicon nitride, silicon oxynitride, zirconium oxide, and hafnium oxide.

At least one of the intermediate insulating layer 203 or the cover layer 205 may include an organic film. The organic film may include at least one among an acrylate-based resin, a methacrylate-based resin, polyisoprene, a vinyl-based resin, an epoxy-based resin, a urethane-based resin, a cellulose-based resin, a siloxane-based resin, a polyimide-based resin, a polyamide-based resin, and a perylene-based resin.

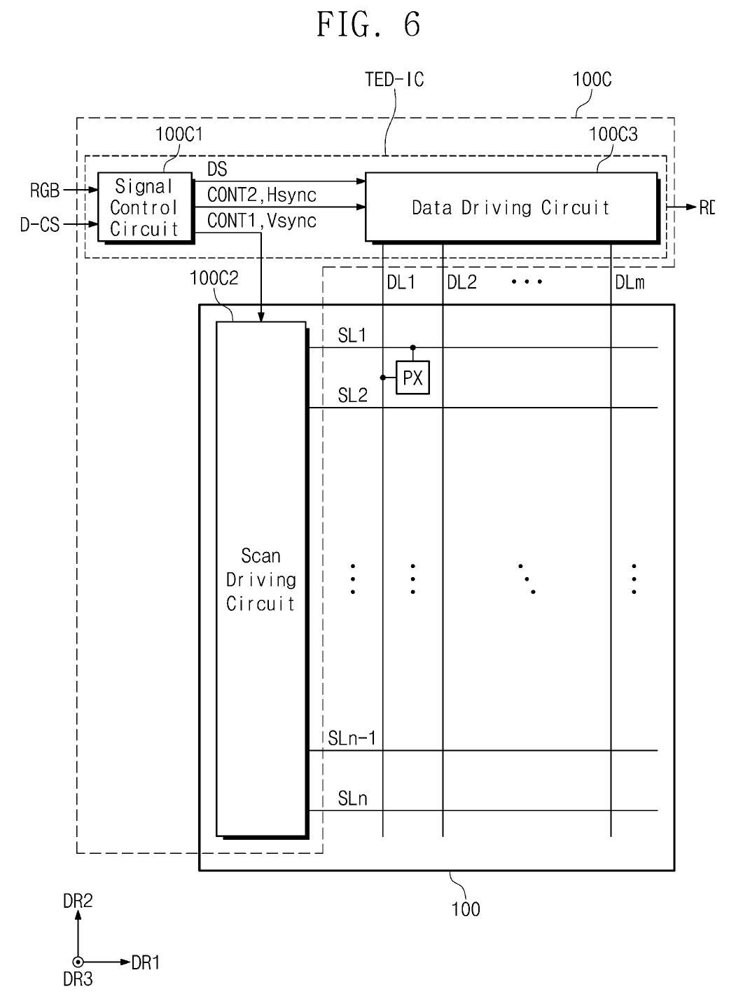

FIG. 6 is a block diagram of the display layer 100 and the display driving unit 100C according to an embodiment of the invention.

Referring to FIG. 6, the display layer 100 may include a plurality of scan lines SL1 to SLn, a plurality of data lines DL1 to DLm, and a plurality of pixels PX.

Each of the pixels PX may be connected to a corresponding data line among the data lines DL1 to DLm and may be connected to a corresponding scan line among the scan lines SL1 to SLn. In an embodiment of the invention, the display layer 100 may further include a plurality of emission control lines, and the display driving unit 100C may further include an emission driving circuit that provides control signals to the emission control lines. The configuration of the display layer 100 is not particularly limited.

Each of the scan lines SL1 to SLn may extend along a first direction DR1, and the scan lines SL1 to SLn may be spaced apart from each other in a second direction DR2. Each of the data lines DL1 to DLm may extend along the second direction DR2, and the data lines DL1 to DLm may be spaced apart from each other in the second direction DR2.

The display driving unit 100C may include a signal control circuit 100C1, a scan driving circuit 100C2, and a data driving circuit 100C3.

The signal control circuit 100C1 may receive the image data RGB and the control signal D-CS from the main driving unit 1000C (see FIG. 3). The control signal D-CS may include various signals. For example, the control signal D-CS may include an input vertical synchronization signal, an input horizontal synchronization signal, a main clock, a data enable signal, and the like.

The signal control circuit 100C1 may generate a first control signal CONT1 and a vertical synchronization signal Vsync based on the control signal D-CS, and may output the first control signal CONT1 and the vertical synchronization signal Vsync to the scan driving circuit 100C2.

The signal control circuit 100C1 may generate a second control signal CONT2 and a horizontal synchronization signal Hsync based on the control signal D-CS, and may output the second control signal CONT2 and the horizontal synchronization signal Hsync to the data driving circuit 100C3.

Additionally, the signal control circuit 100C1 may output, to the data driving circuit 100C3, a driving signal DS obtained by processing the image data RGB according to an operational condition of the display layer 100. The first control signal CONT1 and the second control signal CONT2 are signals for operations of the scan driving circuit 100C2 and the data driving circuit 100C3, and are not particularly limited.

The scan driving circuit 100C2 may drive the scan lines SL1 to SLn in response to the first control signal CONT1 and the vertical synchronization signal Vsync. In an embodiment of the invention, the scan driving circuit 100C2 may be formed through the same process as the process for the circuit layer 120 (see FIG. 5) in the display layer 100, but is not limited thereto. For example, the scan driving circuit 100C2 may be implemented as an integrated circuit (IC) so as to be directly mounted on a predetermined region of the display layer 100, or may be mounted in a chip-on-film (COF) package on a separate printed circuit board so as to be electrically connected to the display layer 100.

The data driving circuit 100C3 may output data voltages to the data lines DL1 to DLm in response to the second control signal CONT2, the horizontal synchronization signal Hsync, and the driving signal DS from the signal control circuit 100C1. Each of the data voltages may have a voltage level corresponding to a gray level of the driving signal DS. The data driving circuit 100C3 may be implemented as an integrated circuit (IC) so as to be directly mounted on a predetermined region of the display layer 100, or may be mounted in a chip-on-film (COF) package on a separate printed circuit board so as to be electrically connected to the display layer 100, but is not limited thereto. For example, the data driving circuit 100C3 may be formed through the same process as the process for the circuit layer 120 (see FIG. 5) in the display layer 100.

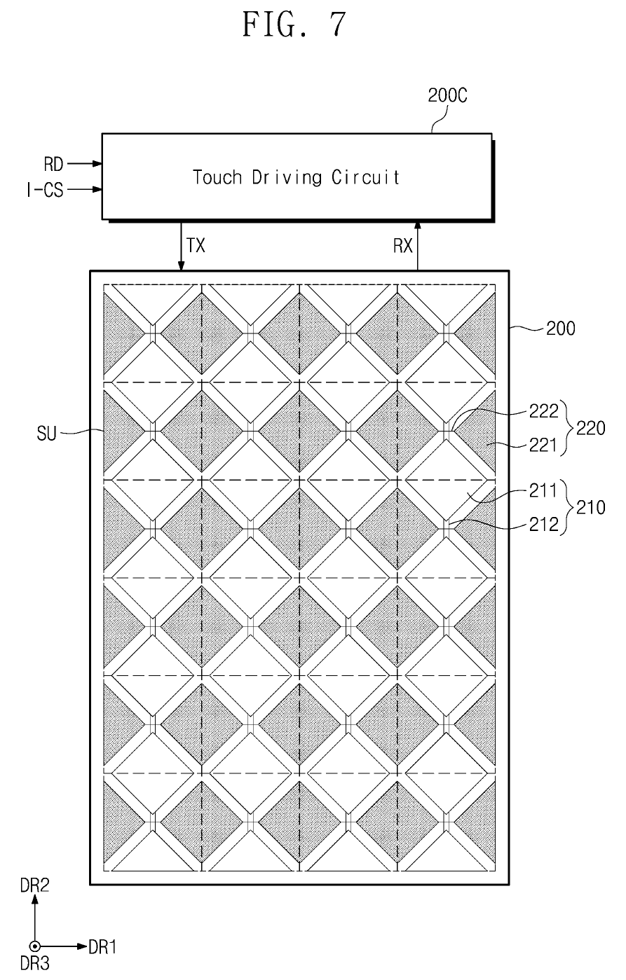

In an embodiment of the invention, the signal control circuit 100C1 and the data driving circuit 100C3 may be built in a single driving chip TED-IC. The single driving chip TED-IC may be referred to as a “display driving circuit TED-IC”. That is, the signal control circuit 100C1 and the data driving circuit 100C3 may be included in the display driving circuit TED-IC. The display driving circuit TED-IC may receive the image data RGB including the information DI (see FIG. 8) about the display image from the outside, and may output, to the touch driving circuit 200C (see FIG. 7), the conversion data RD obtained by converting the received image data RGB. However, this is only an example, and the signal control circuit 100C1 and the data driving circuit 100C3 may be separately formed as respective chips.

FIG. 7 is a block diagram of the sensor layer 200 and the touch driving circuit 200C according to an embodiment of the invention.

Referring to FIGS. 6 and 7, the sensor layer 200 may include a plurality of first sensing electrodes 210 and a plurality of second sensing electrodes 220. The first sensing electrodes 210 may be arranged along the first direction DR1, and each of the first sensing electrodes 210 may extend along the second direction DR2. The second sensing electrodes 220 may be arranged along the second direction DR2, and each of the second sensing electrodes 220 may extend along the first direction DR1. The first sensing electrodes 210 may intersect the second sensing electrodes 220. The sensor layer 200 may further include a plurality of signal lines connected to the first sensing electrodes 210 and the second sensing electrodes 220.

Each of the first sensing electrodes 210 may include a sensing pattern 211 and a bridge pattern 212. Two adjacent sensing patterns 211 may be electrically connected to each other by two bridge patterns 212, but an embodiment of the invention is not limited thereto. The sensing pattern 211 may be included in the second conductive layer 204 (see FIG. 5), and the bridge pattern 212 may be included in the first conductive layer 202 (see FIG. 5).

Each of the second sensing electrodes 220 may include a first portion 221 and a second portion 222. The first portion 221 and the second portion 222 may have an integral shape, and may be disposed at the same layer. For example, the first portion 221 and the second portion 222 may be included in the second conductive layer 204 (see FIG. 5). Two bridge patterns 212 may be insulated from and intersect with the second portion 222.

The touch driving circuit 200C may receive the conversion data RD from the display driving circuit TED-IC and may receive the control signal I-CS from the main driving unit 1000C (see FIG. 3).

The touch driving circuit 200C may be implemented as an integrated circuit so as to be directly mounted on a predetermined region of the sensor layer 200, or may be mounted in a chip-on-film package on a separate printed circuit board so as to be electrically connected to the sensor layer 200.

The touch driving circuit 200C may be driven in a mode of detecting a passive input. The touch driving circuit 200C may output a transmission signal TX to the sensor layer 200. For example, the touch driving circuit 200C may sequentially output the transmission signal TX to the first sensing electrodes 210. Thereinafter, the touch driving circuit200C may receive reception signals RX from the sensor layer 200. For example, the touch driving circuit 200C may receive the reception signals RX from the second sensing electrodes 220.

In an embodiment, the touch driving circuit 200C may sequentially output the transmission signal TX to the second sensing electrodes 220 and may also receive the reception signals RX from the first sensing electrodes 210. In an embodiment, the touch driving circuit 200C may receive the reception signals RX from the first sensing electrodes 210 and the second sensing electrodes 220.

In an embodiment of the invention, the touch driving circuit 200C may adjust the transmission signal TX by referring to the conversion data RD received from the display driving circuit TED-IC. For example, the touch driving circuit 200C may adjust the transmission signal TX by referring to a noise level of the conversion data RD. In addition, the touch driving circuit 200C may receive the reception signal RX from the sensor layer 200 and may adjust the transmission signal TX based on the reception signal RX. For example, the touch driving circuit 200C may adjust the transmission signal TX by referring to noise information of the reception signal RX. Since the touch driving circuit 200C appropriately adjusts the transmission signal TX for each noise level or noise information, the touch sensitivity may be improved according to the adjusted transmission signal TX in a high-noise environment, and a power consumption of the electronic device ED (see FIG. 1) may be reduced according to the adjusted transmission signal TX in a low-noise environment.

A plurality of sensing units SU may be defined in the sensor layer 200. Each of the sensing units SU may include a region in which one first sensing electrode 210 of the first sensing electrodes 210 intersects one second sensing electrode 220 of the second sensing electrodes 220. In FIG. 7, it is illustrated as an example that four sensing units SU are arranged along the first direction DR1, and six sensing units SU are arranged along the second direction DR2. However, the number of sensing units SU is not limited thereto, and the number of sensing units SU may be more or less than the number of sensing units SU illustrated in FIG. 7.

FIG. 8 is a diagram for explaining a driving principle of the display driving circuit TED-IC and the touch driving circuit 200C according to an embodiment of the invention.

Referring to FIGS. 6, 7, and 8, the display driving circuit TED-IC may include a conversion unit CC1 and a compression unit CC2. The touch driving circuit 200C may include a restoring unit CC3, a determination unit CC4, a storage unit CC5, and an adjustment unit CC6.

In an embodiment of the invention, the display driving circuit TED-IC may receive information DI about the display image from the outside. For example, the information DI about the display image may include luminance information about each pixel PX.

In an embodiment of the invention, the conversion unit CC1 may convert the information DI about the display image. The conversion unit CC1 may divide the information DI about the display image into a plurality of blocks and may generate representative value data RD of each of the blocks. The representative value data RD may correspond to the conversion data RD illustrated in FIG. 3. For example, the representative value data RD may include the luminance information about some pixels PX overlapping one of the blocks. The conversion unit CC1 may output the generated representative value data RD to the compression unit CC2.

The compression unit CC2 may compress and encrypt the representative value data RD. That is, the compression unit CC2 may encode the representative value data RD. The compression unit CC2 may output compressed representative value data RDa to the restoring unit CC3 of the touch driving circuit 200C.

The restoring unit CC3 of the touch driving circuit 200C may receive the compressed representative value data RDa from the compression unit CC2 of the display driving circuit TED-IC. In an embodiment of the invention, a communication channel may be used for transmitting the compressed representative value data RDa. For example, the communication channel may include a standardized, general-purpose communication channel that enables data transfer between various devices, or a dedicated communication scheme (protocol) designed to be suitable for a specific purpose or device.

The restoring unit CC3 may receive the compressed representative value data RDa and may restore, that is, decode the compressed representative value data RDa. The restoring process in the restoring unit CC3 may mean reverse processes of compression and encryption that have been performed by the compression unit CC2. The restoring unit CC3 may transfer the restored representative value data RD to the determination unit CC4. Both of the compressed representative value data RDa and the restored representative value data RD may be referred to as “representative value data RD”.

In an embodiment of the invention, the determination unit CC4 may receive the representative value data RD. The determination unit CC4 may determine a noise level NL of the representative value data RD received from the display driving circuit TED-IC. For example, the determination unit CC4 may determine the noise level NL through a relative value of the representative value data RD of each of the blocks including luminance information. The determination unit CC4 may transfer the noise level NL of the representative value data RD to the adjustment unit.

A touch driving condition TDC corresponding to the noise level NL of the representative value data RD may be stored in the storage unit CC5. In an embodiment, the touch driving condition TDC may include voltage data of the transmission signal TX. For example, the touch driving condition TDC may include at least one among a voltage level, the number of voltage pulses, and a voltage frequency of the transmission signal TX.

In an embodiment of the invention, the adjustment unit CC6 may receive the noise level NL from the determination unit CC4 and may receive the touch driving condition TDC corresponding to the noise level NL from the storage unit CC5. The adjustment unit CC6 may adjust the transmission signal TX based on the noise level NL and the touch driving condition TDC corresponding to the noise level NL. For example, the adjustment unit CC6 may adjust at least one among the voltage level, the number of voltage pulses, and the voltage frequency of the transmission signal TX based on the touch driving condition TDC. The adjustment unit CC6 may output the adjusted transmission signal TX to the sensor layer 200.

In an embodiment of the invention, the information DI about the display image received by the display driving circuit TED-IC may be updated on a frame-by-frame basis. Accordingly, the touch driving circuit 200C may adjust the transmission signal TX on the frame-by-frame basis and may output the adjusted transmission signal TX to the sensor layer 200. Therefore, the transmission signal TX may also be updated in real time according to the information DI about the display image that is updated in real time. Since the touch driving circuit 200C adjusts the transmission signal TX in real time, the touch sensitivity may be improved according to the adjusted transmission signal TX in a high-noise environment, and the power consumption of the electronic device ED (see FIG. 1) may be reduced according to the adjusted transmission signal TX in a low-noise environment.

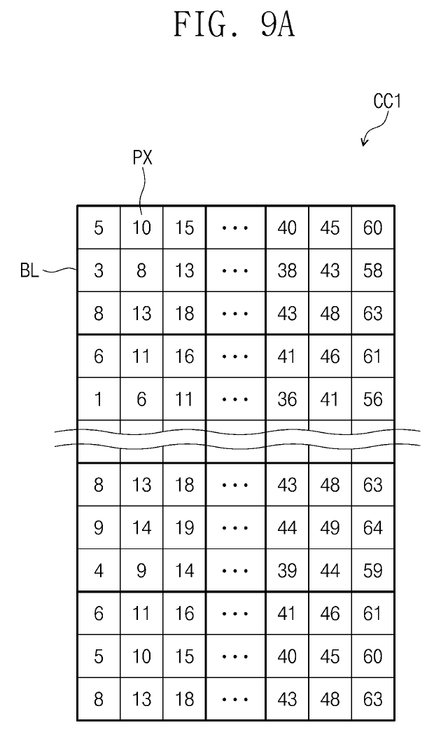

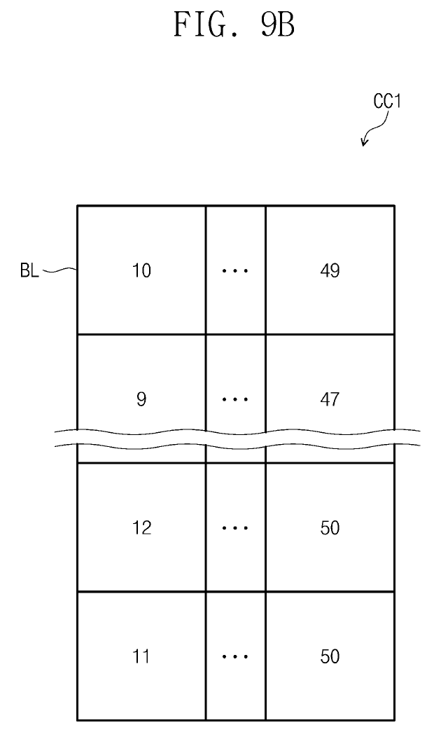

FIG. 9A is a diagram for explaining an operational principle of the conversion unit CC1 according to an embodiment of the invention. FIG. 9B is a diagram for explaining an operational principle of the conversion unit CC1 according to an embodiment of the invention.

Referring to FIGS. 6, 7, 8, 9A, and 9B, the conversion unit CC1 may divide the information DI about the display image into a plurality of blocks BL. In an embodiment of the invention, each of the blocks BL may overlap a portion of the pixels PX. Therefore, the number of the blocks BL may be less than the number of the pixels PX. In an embodiment of the invention, the blocks BL may correspond one-to-one with the sensing units SU. That is, the blocks BL disposed in a first column may correspond to the first one of the first sensing electrodes 210 in row, and the blocks BL disposed in a last column may correspond to the last one of the first sensing electrodes 210 in row.

In FIG. 9A, it is illustrated as an example that one block BL overlaps to nine pixels PX. Therefore, the one block BL may include the information DI about the display image of each of the nine pixels PX. However, an embodiment of the invention is not limited thereto, and the number of the pixels PX overlapping each of the blocks BL may be changed. In an embodiment, the pixels PX may be arranged in 2400 rows and 1080 columns, and the blocks BL may be arranged in 40 rows and 20 columns. That is, one of the blocks BL may overlap the pixels PX that are arranged in 60 rows and 54 columns.

In an embodiment of the invention, the conversion unit CC1 may generate the representative value data RD of each of the blocks BL. The representative value data RD may include the luminance information about a portion of the pixels PX that overlap one of the blocks BL. In an embodiment of the invention, the luminance information may be a relative numerical value from 0 to 100 that represents the luminance of all pixels PX. The luminance information of 0 may be the lowest luminance value that the display layer 100 may represent, and the luminance information of 100 may be the highest luminance value that the display layer 100 may represent. For example, the representative value data RD may be average value data, maximum value data, or minimum value data of the luminance information about the portion of the pixels PX that overlap one of the blocks BL. However, the representative value data RD is not limited thereto, and the representative value data RD may be maximum-value-minus-minimum-value data of the luminance information about the portion of the pixels PX that overlap one of the blocks BL.

In FIG. 9B, it is illustrated as an example that the representative value data RD is the average value data of the luminance information about a portion of the pixels PX that overlap each of the blocks BL. For example, the luminance information about nine pixels PX that overlap the first one of the blocks BL are 5, 10, 15, 3, 8, 13, 8, 13, and 18, respectively, and the representative value data RD of the luminance information may be 10. Additionally, the luminance information about nine pixels PX that overlap the last one of the blocks BL are 41, 46, 61, 40, 45, 60, 43, 48, and 63, respectively, and the representative value data RD of the luminance information may be 50.

In an embodiment of the invention, the conversion unit CC1 may generate the representative value data RD obtained by converting the received information DI about the display image, and the generated representative value data RD may be output to the touch driving circuit 200C through the compression unit CC2.

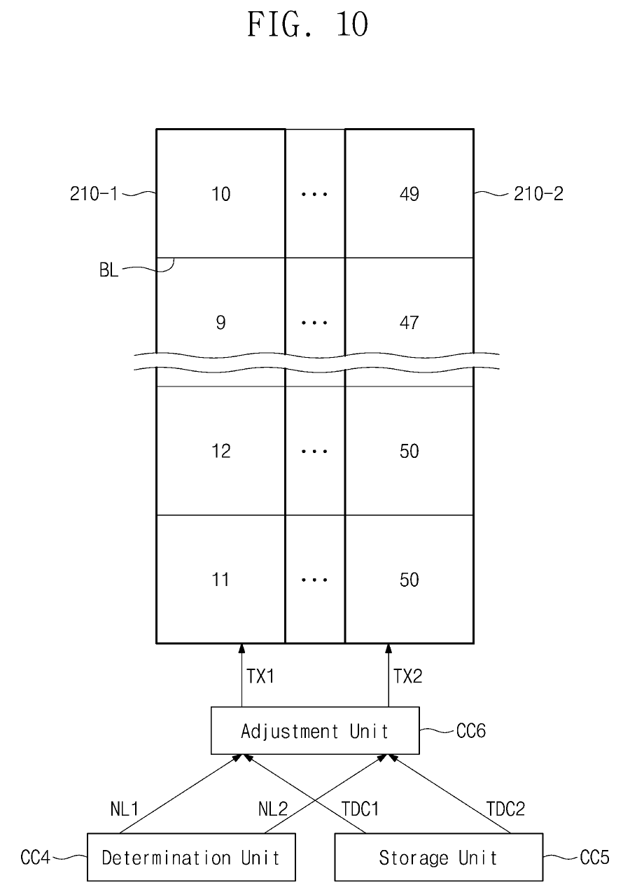

FIG. 10 is a diagram for explaining the transmission signal TX according to an embodiment of the invention. In FIG. 10, the description made with reference to FIG. 8 is similarly applied, and the differences from FIG. 8 are mainly explained.

Referring to FIGS. 7, 8, 9B, and 10, the adjustment unit CC6 of the touch driving circuit 200C may adjust the transmission signal TX based on the touch driving condition corresponding to each of the first sensing electrodes 210. For example, the determination unit CC4 may determine the noise level NL of the representative value data RD corresponding to each of the first sensing electrodes 210, and the adjustment unit CC6 may adjust the transmission signal TX of each of the first sensing electrodes 210 based on the touch driving condition TDC corresponding to the noise level NL and received from the storage unit CC5.

In an embodiment, a first noise level NL1 corresponding to the case where the representative value data RD is 20 or less may correspond to the first touch driving condition TDC1, and a second noise level NL2 corresponding to the case where the representative value data RD is 40 or more may correspond to the second touch driving condition TDC2. The adjustment unit CC6 may be configured to output the first transmission signal TX1 based on the first touch driving condition TDC1 corresponding to the first noise level NL1 and may be configured to output the second transmission signal TX2 based on the second touch driving condition TDC2 corresponding to the second noise level NL2. Accordingly, the touch driving circuit 200C may output the first transmission signal TX1 to the first one of the first sensing electrodes 210-1 corresponding to the blocks BL arranged in the first column and may output the second transmission signal TX2 to the last one of the first sensing electrodes 210-2 corresponding to the blocks BL arranged in the last column.

According to an embodiment of the invention, since the touch driving circuit 200C may adjust the transmission signal TX corresponding to each of the first sensing electrodes 210 arranged in the sensor layer 200, the touch sensitivity may be improved, and the power consumption of the electronic device ED (see FIG. 1) may be reduced.

In an embodiment of the invention, the transmission signal TX may be adjusted based on a block having the highest noise level among the blocks BL arranged in one column. For example, for the blocks BL arranged in the first column, the first transmission signal TX1 may be adjusted based on 12, which is the representative value data RD of the block BL arranged in the third row, and for the blocks BL arranged in the last column, the second transmission signal TX2 may be adjusted based on 50, which is the representative value data RD of the blocks BL arranged in the third and fourth rows.

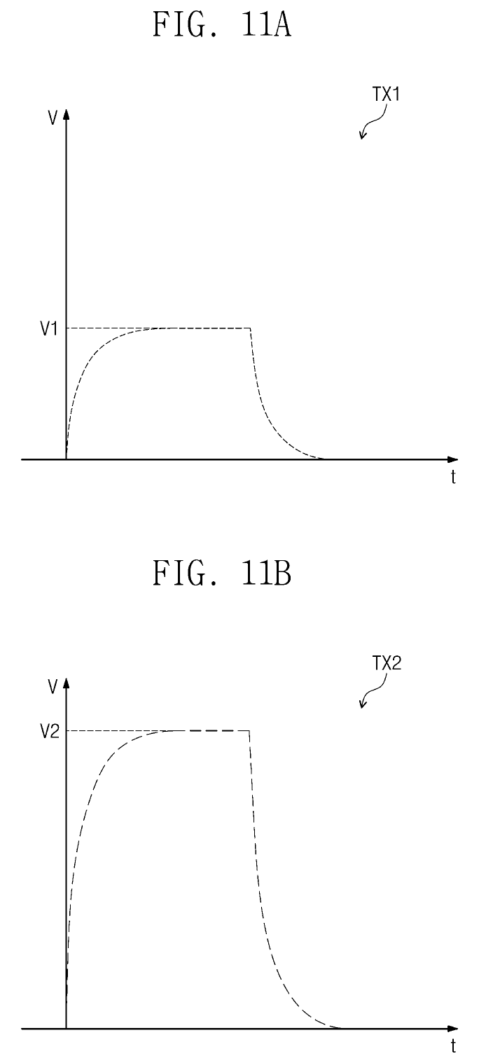

FIG. 11A is a diagram illustrating the first transmission TX1 shown in FIG. 10, according to an embodiment of the invention. FIG. 11B is a diagram illustrating the second transmission TX2 shown in FIG. 10, according to an embodiment of the invention.

Referring to FIGS. 8, 10, 11A, and 11B, the first touch driving condition TDC1 may include a voltage level V1 of the first transmission signal TX1, and the second touch driving condition TDC2 may include a voltage level V2 of the second transmission signal TX2. For example, the first transmission signal TX1 may have a first voltage level V1, and the second transmission signal TX2 may have a second voltage level V2. In an embodiment, the first voltage level V1 may be less than the second voltage level V2.

According to the invention, the first transmission signal TX1 having a low voltage level is output to the first sensing electrodes 210-1 that overlap the blocks BL having a low noise level NL, and accordingly the power consumption of the electronic device ED (see FIG. 1) may be reduced. Furthermore, the second transmission signal TX2 having a high voltage level is output to the first sensing electrodes 210-2 that overlap the blocks BL having a high noise level NL, and accordingly the touch sensitivity may be improved.

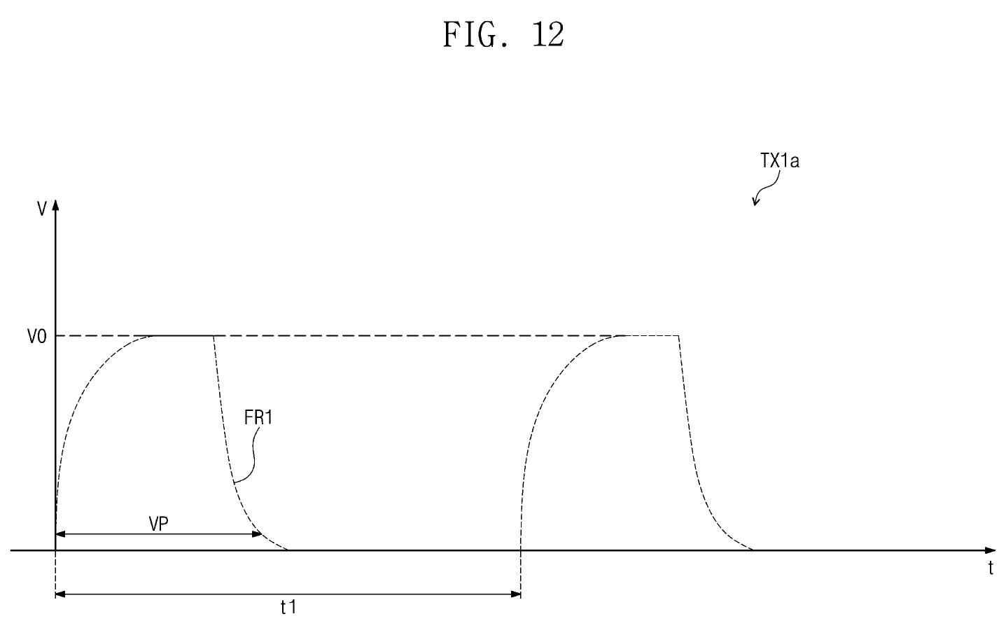

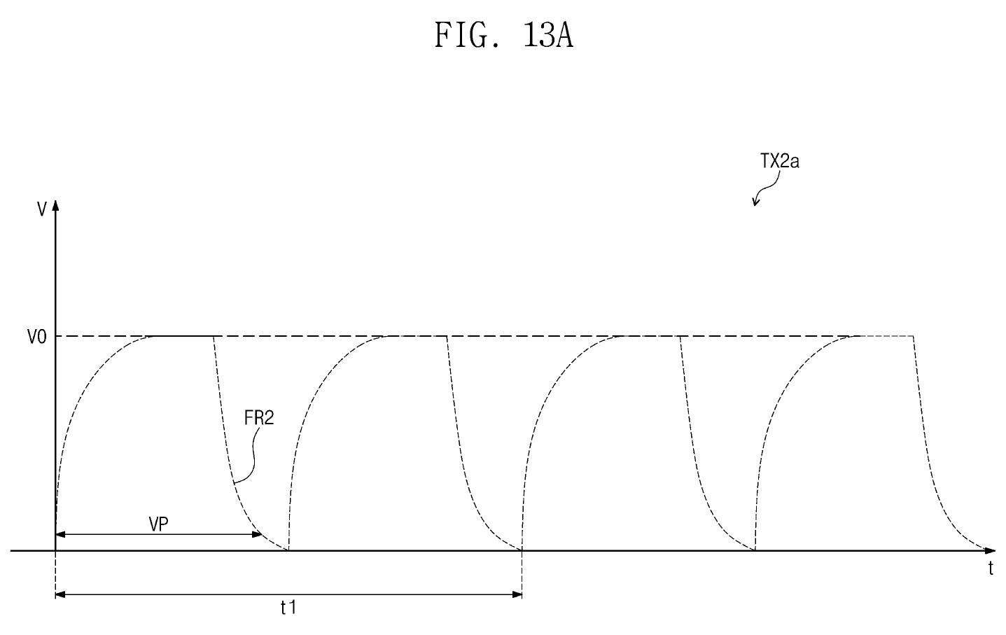

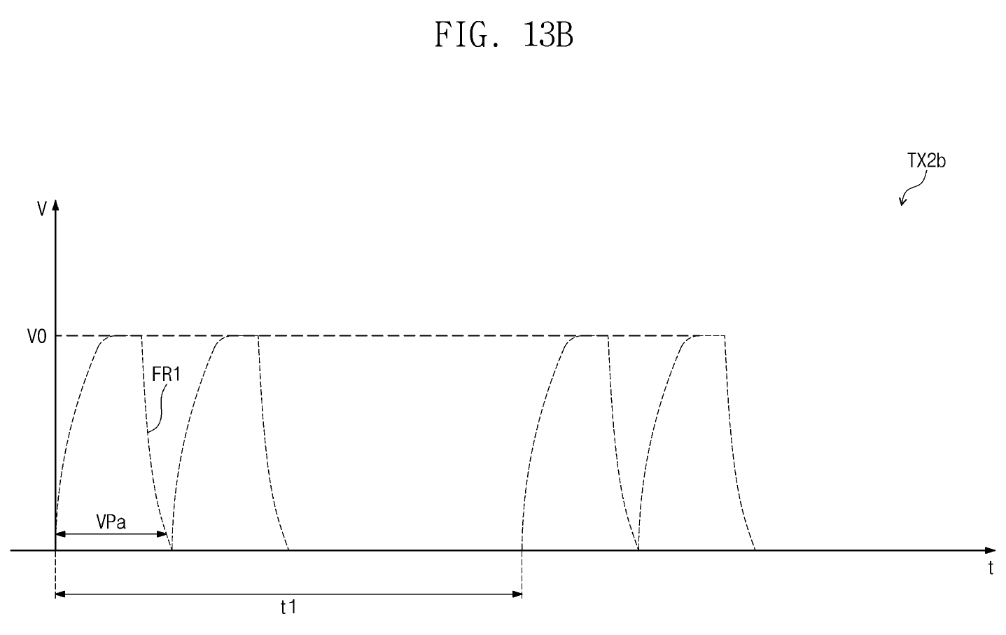

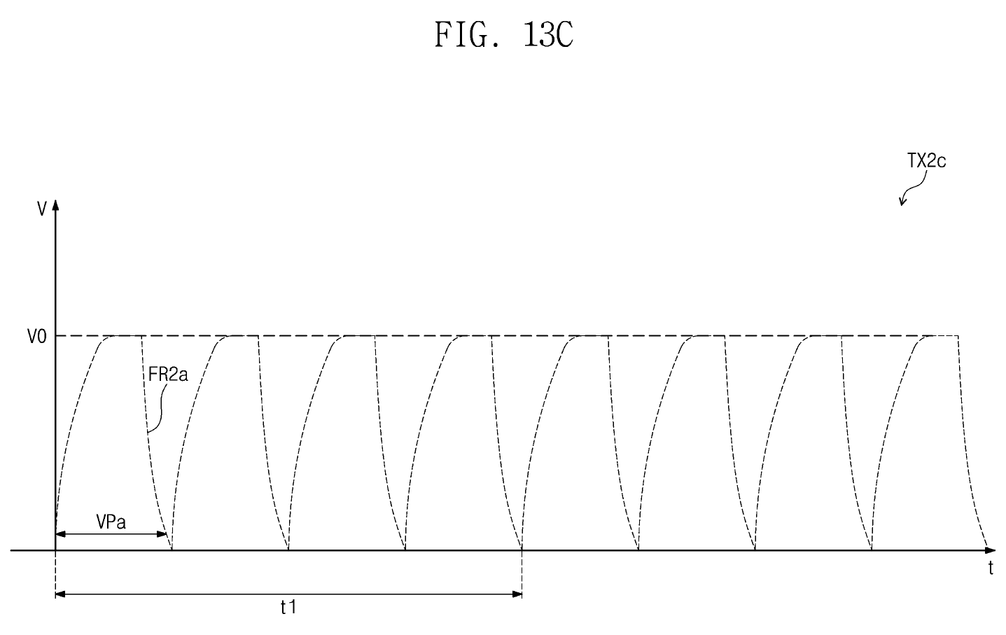

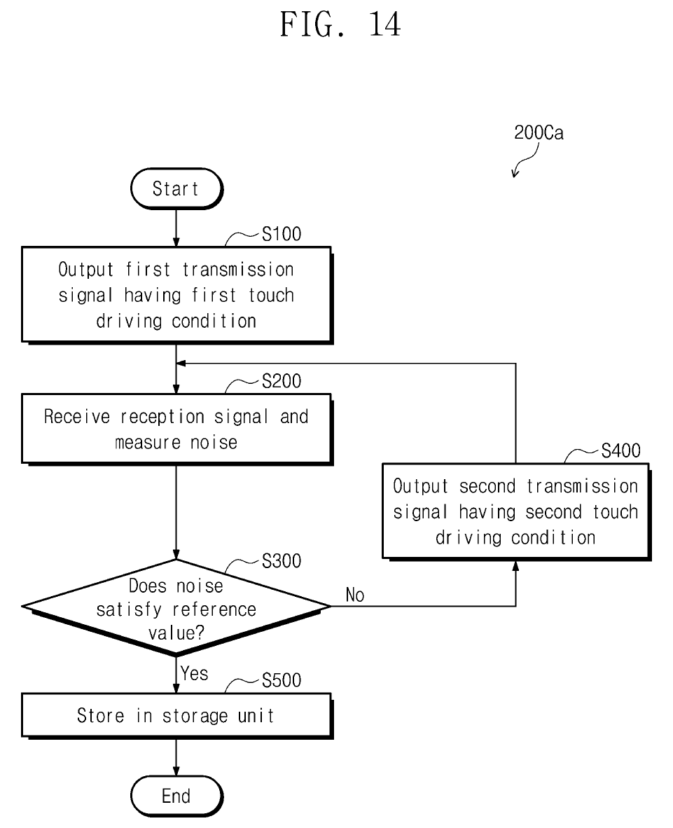

FIG. 12 is a diagram illustrating a first transmission signal TX1a shown in FIG. 10, according to an embodiment of the invention. FIG. 13A is a diagram illustrating a second transmission signal TX2a shown in FIG. 10, according to an embodiment of the invention.

Referring to FIGS. 8, 10, 12, and 13A, the first touch driving condition TDC1 may include the number of voltage pulses VP and a voltage frequency FR1 of the first transmission signal TX1a, and the second touch driving condition TDC2 may include the number of voltage pulses VP and a voltage frequency FR2 of the second transmission signal TX2a. For example, the number of the voltage pulses VP of the first transmission signal TX1a, and the number of the voltage pulses VP of the second transmission signal TX2a which are output during the same period of time may be 2 and 4, respectively.

In an embodiment of the invention, the first transmission signal TX1a and the second transmission signal TX2a may have different frequencies for the same reference interval T1. For example, the first transmission signal TX1a may have a first voltage frequency FR1, and the second transmission signal TX2a may have a second voltage frequency FR2. In an embodiment, the first voltage frequency FR1 may be lower than the second voltage frequency FR2. In an embodiment, the width of the voltage pulse VP of the first transmission signal TX1a and the width of the voltage pulse VP of the second transmission signal TX2a may be equal to each other.

According to the invention, the first transmission signal TX1a having a small number of the voltage pulses VP and a low frequency is output to the first sensing electrodes 210-1 that overlap the blocks BL having a low noise level NL, and therefore the power consumption of the electronic device ED (see FIG. 1) may be reduced. Furthermore, the second transmission signal TX2a having a large number of the voltage pulses VP and a high frequency is output to the first sensing electrodes 210-2 that overlap the blocks BL having a high noise level NL, and therefore the touch sensitivity may be improved.

FIG. 13B is a diagram illustrating a second transmission signal TX2b shown in FIG. 10, according to an embodiment of the invention. In FIG. 13B, the description made with reference to FIG. 13A is similarly applied, and differences from FIG. 13A are mainly explained.

Referring to FIGS. 8, 10, 12, and 13B, the second touch driving condition TDC2 may include the number of voltage pulses VPa and the voltage frequency FR1 of the second transmission signal TX2b. For example, the number of the voltage pulses VP of the first transmission signal TX1a and the number of the voltage pulses VPa of the second transmission signal TX2b which are output during the same period of time may be 2 and 4, respectively.

In an embodiment of the invention, the first transmission signal TX1a and the second transmission signal TX2b may have the same first voltage frequency FR1. In an embodiment, the width of the voltage pulse VP of the first transmission signal TX1a may be greater than the width of the voltage pulse VPa of the second transmission signal TX2b.

According to the invention, the first transmission signal TX1a having a small number of the voltage pulses VP is output to the first sensing electrodes 210-1 that overlap the blocks BL having a low noise level NL, and therefore the power consumption of the electronic device ED (see FIG. 1) may be reduced. Furthermore, the second transmission signal TX2b having a large number of the voltage pulses VP is output to the first sensing electrodes 210-2 that overlap the blocks BL having a high noise level NL, and therefore the touch sensitivity may be improved.

FIG. 13C is a diagram illustrating a second transmission signal TX2c shown in FIG. 10, according to an embodiment of the invention. In FIG. 13C, the description made with reference to FIG. 13A is similarly applied, and differences from FIG. 13A are mainly explained.

Referring to FIGS. 8, 10, 12, and 13C, the second touch driving condition TDC2 may include the number of voltage pulses VPa of and a voltage frequency FR2a of the second transmission signal TX2c. For example, the number of the voltage pulses VP of the first transmission signal TX1a, and the number of the voltage pulses VPa of the second transmission signal TX2c which are output during the same period of time may be 2 and 8, respectively.

In an embodiment of the invention, the first transmission signal TX1a and the second transmission signal TX2c may have different frequencies for the same reference interval T1. For example, the first transmission signal TX1a may have a first voltage frequency FR1, and the second transmission signal TX2c may have a second voltage frequency FR2a. In an embodiment, the first voltage frequency FR1 may be lower than the second voltage frequency FR2a. In an embodiment, the width of the voltage pulse VP of the first transmission signal TX1a may be greater than the width of the voltage pulse VPa of the second transmission signal TX2c.

According to the invention, the first transmission signal TX1a having a small number of the voltage pulses VP and a low frequency is output to the first sensing electrodes 210-1 that overlap the blocks BL having a low noise level NL, and therefore the power consumption of the electronic device ED (see FIG. 1) may be reduced. Furthermore, the second transmission signal TX2c having a large number of the voltage pulses VP and a high frequency is output to the first sensing electrodes 210-2 that overlap the blocks BL having a high noise level NL, and therefore the touch sensitivity may be improved.

In FIGS. 12 to 13C, it is illustrated as an example that the voltage level V0 of the first transmission signal TX1a is equal to the voltage level V0 of the second transmission signal TX2a, TX2b, or TX2c, but is not particularly limited thereto. For example, an additional adjustment may be performed such that the voltage level of the second transmission signal TX2a, TX2b, or TX2c is higher than the voltage level of the first transmission signal TX1a. Additionally, as shown in FIG. 13A, in the second transmission signal TX2b of FIG. 13B, a pulse may be further added in an interval in which no waveform is present between pulses.

FIGS. 11A and 11B each illustrate as an example that the voltage levels of the first transmission signal TX1 and the second transmission signal TX2 are different from each other, and FIGS. 12 to 13C each illustrate as an example that the first transmission signal TX1a and the second transmission signal TX2a, TX2b, or TX2c, are different in the number of voltage pulses and voltage frequency from each other. However, an embodiment of the invention is not limited thereto, and the first transmission signal and the second transmission signal may be different from each other in at least one combination of the voltage level, the number of voltage pulses, and the voltage frequency.

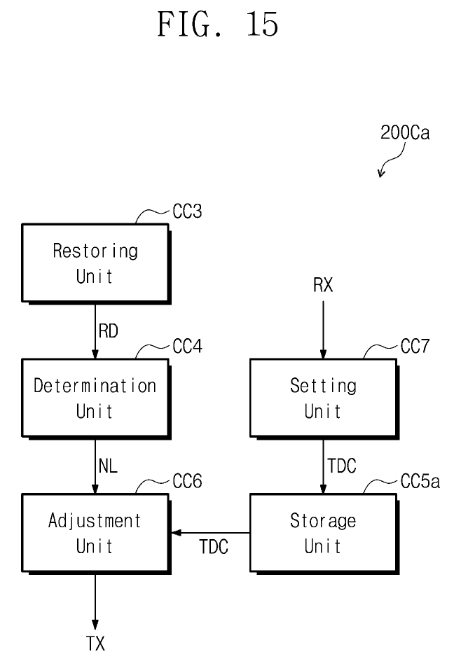

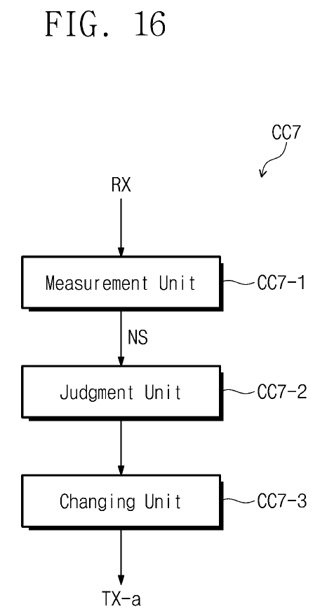

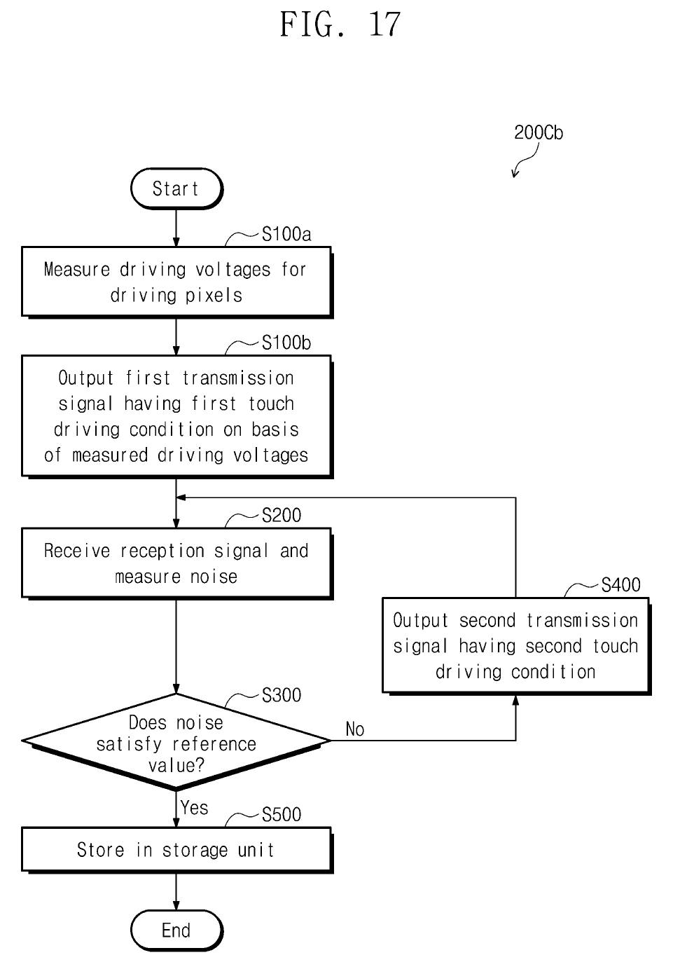

FIG. 14 is a diagram for explaining a driving principle of a touch driving circuit 200Ca according to an embodiment of the invention. FIG. 15 is a diagram for explaining a driving principle of the touch driving circuit 200Ca according to an embodiment of the invention. FIG. 16 is a diagram for explaining an operational principle of a setting unit CC7 according to an embodiment of the invention. In FIGS. 14, 15, and 16, the description made with reference to FIG. 8 is similarly applied, and differences from FIG. 8 are mainly explained.

Referring to FIGS. 7, 8, 14, 15, and 16, the touch driving circuit 200Ca may output, to the sensor layer 200, the first transmission signal that has the first touch driving condition. In this case, the first touch driving condition may be a test driving condition.

In an embodiment of the invention, the touch driving circuit 200Ca may further include the setting unit CC7 for receiving the reception signal RX from the sensor layer 200 and setting the touch driving condition TDC1 based on the reception signal RX. The setting unit CC7 may include a measurement unit CC7-1, a judgment unit CC7-2, and a changing unit CC7-3.

The measurement unit CC7-1 may receive the reception signal RX from the sensor layer 200 that receives the first transmission signal having the first touch driving condition and may measure a noise information NS (S200). In an embodiment, the noise information NS may include a signal-to-noise ratio SNR and a touch-to-display noise TDN. For example, the signal-to-noise ratio may represent a ratio between signal intensity and noise, and as the signal-to-noise ratio is higher, the touch sensitivity becomes higher. The touch-to-display noise is the noise, which affects the display and which is caused by the touch. Therefore, as the touch-to-display noise value is lower, an image with less distortion may be displayed. The measurement unit CC7-1 may output, to the judgment unit CC7-2, the measured noise information NS obtained by receiving and measuring the reception signal RX.

The judgment unit CC7-2 may judge whether the first touch driving condition satisfies a reference value based on the noise information NS received from the measurement unit CC7-1 (S300). For example, the reference value may be the signal-to-noise ratio of 23 decibels (dB) and the touch-to-display noise of 0.6 but is not particularly limited thereto. The judgment unit CC7-2 may judge that the noise information NS satisfies the reference value, when the signal-to-noise ratio is 23 dB or more and the touch-to-display noise is 0.6 or less.

In an embodiment of the invention, a storage unit CC5a may be configured to store the first touch driving condition when the first touch driving condition satisfies the reference value (S500).

In an embodiment of the invention, when the first touch driving condition does not satisfy the reference value, the changing unit CC7-3 may generate the second transmission signal TX-a that has the second touch driving condition different from the first touch driving condition. The changing unit CC7-3 may output, to the sensor layer 200, the second transmission signal TX-a that has the second touch driving condition.

In an embodiment of the invention, the noise information may be measured by receiving the reception signal from the sensor layer 200 that receives the second transmission signal TX-a having a second touch driving condition, and whether the second touch driving condition satisfies the reference value may be judged based on the noise information. When the second touch driving condition satisfies the reference value, the storage unit CC5a may be configured to store the second touch driving condition; and when the second touch driving condition does not satisfy the reference value, the changing unit CC7-3 may output a transmission signal having a different touch driving condition than the second transmission signal TX-a having the second touch driving condition.

According to the invention, the storage unit CC5a may store optimal touch driving conditions that satisfy the reference value. For example, the storage unit CC5a may store, in the form of a look-up table, the optimal touch driving conditions respectively corresponding to a plurality of display images. In an embodiment, the optimal touch driving conditions may be stored in advance before shipment of products. For example, the lookup table containing the touch driving conditions may be stored in parallel with an image quality compensation test step prior to the shipment of products.

FIG. 17 is a diagram for explaining a driving principle of a touch driving circuit 200Cb according to an embodiment of the invention. In FIG. 17, the description made with reference to FIG. 14 is similarly applied, and differences from FIG. 14 are mainly explained.

Referring to FIGS. 6, 7, 8, 14, and 17, the touch driving circuit 200Cb may measure driving voltages for driving pixels PX (S100a). For example, the driving voltages may include a first driving voltage (a high voltage supplied to driving pixels PX) and a second driving voltage (a low voltage supplied to driving pixels PX).

The touch driving circuit 200Cb may output a first transmission signal having a first touch driving condition based on the measured driving voltages (S100b). When the driving voltages for driving the pixels PX are measured, a noise level of the display layer 100 due to changes of the driving voltages, and the like may be determined. Therefore, when the first transmission signal having the first touch driving condition is output based on the driving voltages, it is possible to output a first transmission signal having a first touch driving condition close to a reference value according to the noise level that has been already determined.

According to the above description, an electronic device may include a display driving circuit that receives information about a display image from the outside, and a touch driving circuit that outputs a transmission signal to a sensor layer. The touch driving circuit may adjust the transmission signal by referring to a noise level of a representative value data received from the display driving circuit. Additionally, the touch driving circuit may receive a reception signal from the sensor layer and may adjust the transmission signal by referring to noise information. Since the touch driving circuit may appropriately adjust the transmission signal for each noise level or noise information, a touch sensitivity may be improved according to the adjusted transmission signal in a high noise environment, and a power consumption of the electronic device may be reduced according to the adjusted transmission signal in a low noise environment.

In the above, description has been made with reference to embodiments of the invention, but those skilled or of ordinary skill in the art may understand that various modifications and changes may be made to the invention insofar as such modifications and changes do not depart from the spirit and technical scope of the invention set forth in the claims to be described later.

Therefore, the technical scope of the invention is not to be limited to the contents stated in the detailed description of the specification, but should be determined by the claims.

What is claimed is:

1. An electronic device comprising:
a display panel comprising a display layer, which displays an image, and a sensor layer, which detects an external input;
a display driving circuit, which receives information about a display image from an outside and outputs a data voltage to the display layer; and
a touch driving circuit, which outputs a transmission signal to the sensor layer,
wherein the display driving circuit comprises a conversion unit, which divides the information about the display image into a plurality of blocks and generates representative value data of each of the plurality of blocks, and
the touch driving circuit comprises a determination unit, which determines a noise level of the representative value data received from the display driving circuit, a storage unit in which a touch driving condition corresponding to the noise level is stored, and an adjustment unit, which adjusts the transmission signal based on the touch driving condition.

2. The electronic device of claim 1, wherein the information about the display image is updated on a frame-by-frame basis, and
the touch driving circuit adjusts the transmission signal on the frame-by-frame basis.

3. The electronic device of claim 1, wherein the sensor layer comprises a plurality of first sensing electrodes and a plurality of second sensing electrodes intersecting the plurality of first sensing electrodes,
the transmission signal is output to each of the plurality of first sensing electrodes, and
the adjustment unit adjusts the transmission signal based on the touch driving condition corresponding to each of the plurality of first sensing electrodes.

4. The electronic device of claim 1, wherein the sensor layer comprises a plurality of first sensing electrodes and a plurality of second sensing electrodes intersecting the plurality of first sensing electrodes,
the touch driving circuit receives a reception signal from the plurality of second sensing electrodes, and
the touch driving circuit further comprises a setting unit, which sets the touch driving condition based on the reception signal.

5. The electronic device of claim 4, wherein the setting unit comprises:
a measurement unit, which receives the reception signal from the sensor layer which receives a first transmission signal having a first touch driving condition and measures noise information; and
a judgment unit, which judges whether the first touch driving condition satisfies a reference value based on the noise information, and
when the first touch driving condition satisfies the reference value, the storage unit is configured to store the first touch driving condition.

6. The electronic device of claim 5, wherein the setting unit further comprises a changing unit, which generates a second transmission signal, having a second touch driving condition different from the first touch driving condition, when the first touch driving condition does not satisfy the reference value.

7. The electronic device of claim 1, wherein the display layer comprises a plurality of pixels, and
a total number of the plurality of blocks is less than a total number of the plurality of the pixels.

8. The electronic device of claim 1, wherein the sensor layer comprises a plurality of first sensing electrodes and a plurality of second sensing electrodes intersecting the plurality of first sensing electrodes,
the sensor layer has a plurality of sensing units defined therein,
each of the plurality of sensing units comprises a region in which one first sensing electrode among the plurality of first sensing electrodes intersects one second sensing electrode among the plurality of second sensing electrodes, and
the plurality of blocks correspond one-to-one with the plurality of sensing units.

9. The electronic device of claim 1, wherein the display layer comprises a plurality of pixels, and
the representative value data comprises luminance information about some pixels, among the plurality of pixels, which overlap one block among the plurality of blocks.

10. The electronic device of claim 9, wherein the representative value data is average value data of the luminance information about the some pixels.

11. The electronic device of claim 9, wherein the representative value data is maximum value data of the luminance information about the some pixels.

12. The electronic device of claim 1, wherein the touch driving condition comprises voltage data of the transmission signal.

13. The electronic device of claim 1, wherein the display driving circuit further comprises a compression unit, which compresses the representative value data, and
the touch driving circuit further comprises a restoring unit, which restores the compressed representative value data and transfers the representative value data, which is restored from the compression, to the determination unit.

14. An electronic device comprising:
a display panel comprising a display layer, which displays an image and a sensor layer, which detects an external input;
a display driving circuit, which receives information about a display image from an outside, and outputs a data voltage to the display layer; and
a touch driving circuit, which outputs a transmission signal to the sensor layer,
wherein the display driving circuit comprises a conversion unit, which divides the information about the display image into a plurality of blocks and generates representative value data of each of the plurality of blocks, and a compression unit, which compresses the representative value data and transfers the compressed representative value data to the touch driving circuit,
the touch driving circuit comprises a restoring unit, which receives and restores the compressed representative value data, a determination unit, which determines a noise level of the representative value data, which is restored, a storage unit in which a touch driving condition corresponding to the noise level is stored, and an adjustment unit, which adjusts the transmission signal based on the touch driving condition.

15. The electronic device of claim 14, wherein the information about the display image is updated on a frame-by-frame basis, and
the touch driving circuit adjusts the transmission signal on the frame-by-frame basis.

16. The electronic device of claim 14, wherein the sensor layer comprises a plurality of first sensing electrodes and a plurality of second sensing electrodes intersecting the plurality of first sensing electrodes,
the transmission signal is output to each of the plurality of first sensing electrodes, and
the adjustment unit adjusts the transmission signal based on the touch driving condition corresponding to each of the plurality of first sensing electrodes.

17. The electronic device of claim 14, wherein the sensor layer comprises a plurality of first sensing electrodes and a plurality of second sensing electrodes intersecting the plurality of first sensing electrodes,
the touch driving circuit receives a reception signal from the plurality of second sensing electrodes, and
the touch driving circuit further comprises a setting unit, which sets the touch driving condition based on the reception signal.

18. The electronic device of claim 17, wherein the setting unit comprises:
a measurement unit, which receives the reception signal from the sensor layer which receives a first transmission signal having a first touch driving condition and measures noise information;
a judgment unit, which judges whether the first touch driving condition satisfies a reference value based on the noise information; and
a changing unit, which generates a second transmission signal having a second touch driving condition different from the first touch driving condition when the first touch driving condition does not satisfy the reference value, and
the storage unit is configured to store the first touch driving condition when the first touch driving condition satisfies the reference value.

19. The electronic device of claim 14, wherein the display layer comprises a plurality of pixels,
the sensor layer comprises a plurality of first sensing electrodes and a plurality of second sensing electrodes intersecting the plurality of first sensing electrodes,
the sensor layer has a plurality of sensing units defined therein, the plurality of sensing units each comprising a region in which one first sensing electrode among the plurality of first sensing electrodes intersects one second sensing electrode among the plurality of second sensing electrodes,
a total number of the plurality of blocks is less than a total number of the plurality of pixels, and
the plurality of blocks correspond one-to-one with the plurality of sensing units.

20. The electronic device of claim 14, wherein the display layer comprises a plurality of pixels,
the representative value data comprises luminance information about some pixels, among the plurality of pixels, which overlap one block among the plurality of blocks, and
the touch driving condition comprises voltage data of the transmission signal.
